(19) United States
(12) Patent Application Publication
(10) Pub. No.: US 2017/0026081 A1
(43) Pub. Date: Jan. 26, 2017

(54) METHOD FOR PERFORMING PAIRING IN ACCESS NETWORK APPLIED G.HN TECHNOLOGY THERETO, ACCESS NETWORK MULTIPLEXER (GAM), ACCESS NETWORK TERMINAL (GNT), AND ACCESS NETWORK SYSTEM USING THE SAME

(71) Applicant: UBIQUOSS INC., Seongnam-si (KR)

(72) Inventor: Byung Gil JUNG, Seoul (KR)

(73) Assignee: UBIQUOSS INC., Seongnam-si (KR)

(21) Appl. No.: 15/301,387

(22) PCT Filed: Mar. 26, 2015
(86) PCT No.: PCT/KR2015/002975

§ 371 Date: Oct. 1, 2016

(30) Foreign Application Priority Data
Apr. 1, 2014 (KR) 10-2014-0038628
Apr. 1, 2014 (KR) 10-2014-0038629
Apr. 1, 2014 (KR) 10-2014-0038631
Apr. 1, 2014 (KR) 10-2014-0038632
Oct. 21, 2014 (KR) 10-2014-0142268

(51) Int. Cl. H04B 3/32; H04Q 11/00; H04L 29/12; H04B 3/52

(52) U.S. Cl. CPC H04B 3/32; H04B 3/52; H04Q 11/0067; H04L 61/3025; H04L 61/6022; H04Q 2011/0049

(57) ABSTRACT

The present invention relates to a method for GIGA wire auto pairing, in more details the method for performing auto pairing between a domain master and end-point in an access network forming a G.hn domain including access network multiplexer (GAM) in which multiple ports are functioning as domain masters, a terminal (GNT) which includes an end-point forming a G.hn domain with the domain master, and a bundle cable connecting the domain master with the end-point. The auto pairing process is performed by activating ports and starting opening-up, and linking the domain master and the end-point using a seed value, then if the link is set up, automatically registering MAC address of the end-point using previously saved MAC address of the end-point. And thus the domain master is connected only with the registered end-point in the relink process. According to the present invention, it is unlikely to confuse different lines as the same lines.

### BACKGROUND

The present invention relates to an access network providing gigabit rate Ethernet service by forming a G.hn domain in which an access network multiplexer (also calles as G.hn access multiplexer (GAM) or access multiplexer hereinafter) and access network terminals (also calles as a G.hn access terminal (GNT) or terminal hereinafter) are connected through a conventional phone line without adding or changing the line, and GIGA wire automatic pairing method using the access network. More specifically, by applying the G.hn specification to the conventional apartment equipped with a pair of phone line, gigabit rate service, 3-5 times faster than the conventional speed, is made possible without installing additional phone line, but the problem of crosstalk due to high frequencies arises. In this circumstance, the automatic Giga wire pairing method configures beforehand a domain name in the domain master and the end-point respectively before opening-up while the seed value is pre-configured at the domain master only, the pairing between the domain master and the end-point is made by sending the seed value in the MAP-D frame which the domain master sends to the end-point, and the configuration is automatically saved with protocol based MAC authentication. In this way the present invention prevents identifying different lines as the same lines and eliminates communication errors in the MAC authentication process between an operator and an installer.

Generally, gigabit rate service (1 Gbps) are replacing conventional 100 Mbps service and getting prevalent as the bandwidth provided to a subscriber are required to increase because of rapid increase of traffic.

FIG. 1 is a block diagram for representing the access network configuration based on the conventional DSL.

Referring to FIG. 1, the optical fiber line is used for data communication between the upper layer communication equipment and digital subscriber line access multiplexer (DSLAM), and the phone line is used to transfer data between digital subscriber line access multiplexer (DSLAM) and the residential modem (Modem) in the conventional DSL based access network.

The conventional apartments or buildings constructed from 20 to 30 years ago are equipped with a pair of phone line. In case of decrepit apartments, for example, the wiring from MDF terminal box to a subscriber's house uses a pair of phone line. Hence, it is impossible to provide gigabit rate service for the conventional apartments or buildings in Korea (it is also true for a number of European territories where change of line is difficult due to ancient remains).

Such change of line or installation of additional line is impossible or, if possible, cumbersome to acquire consent of residents. Hence communication service providers want to increase bandwidth without change of line or installation of additional line.

Meanwhile, the G.hn to increase the bandwidth from 100 Mbps to 1 Gbps without installation of additional line is introduced.

For example, applying the G.hn specification to the access network consisting of a central office (CO) having multiple ports and multiple customer premises equipment (CPE) is an attempt to increase bandwidth from 100 Mbps to 1 Gbps.

While an access network using phone line can provide theoretically gigabit rate (1 Gbps) service by employing G.hn specification, it is, however, difficult to provide gigabit rate service in the access network because the crosstalk in adjacent lines in the access network consisting of a bundle cable causes identifying different lines as the same lines.

For example, the communications in an access network connected with phone lines is sensitive to the interference in a bundle cable; the interference between lines in the bundle cable is severe in the frequency band between 2 MHz and 100 MHz which the G.hn specification uses (while the crosstalk does not occur in a DSL-based access network since it uses low frequency band); and if a terminal is powered on (Power Up), a link is set up (Link Up), or data is sent or received, the line signal of other terminals is attenuated or distorted due to the interference.

Hence applying the G.hn specification to an access network requires a method eliminating the Near End crosstalk (NEXT).

### SUMMARY

Therefore the present invention is devised to solve problems of the conventional technology as described above and the objective of the present invention is to provide a GIGA wire automatic pairing method in a G.hn-based access network, which solves cumbersome problems occurring in the pairing process via MAC authentication between a domain master and an end-point having the factory default value as an initial seed, and uses given domain name and seed value to reduce the crosstalk caused by high frequency, but decides how to specify the domain name and seed value in access network system.

Another objective of the present invention is to provide a G.hn-based access network and a GIGA wire automatic pairing method preventing an error of saving a wrong seed value by establishing a protocol based MAC authentication in which at least each port of a domain master has a seed value and an end-point acquires a seed value in the opening-up process to eliminate inconvenience in the opening-up process in which a domain master and an end-point having initial default values share a seed value with MAC authentication.

According to a feature of the present invention to achieve the objectives described earlier, the GIGA wire automatic pairing method in the present invention relates an automatic pairing method between a domain master and an end-point in order to form a G.hn domain among G.hn access multiplexer (GAM) and terminals (GNT) connected with a phone line; a domain name and a seed value of the domain master is set up; a domain name of the end-point is set up; the wiring between the G.hn access multiplexer (GAM) for a port to be opened and the terminal (GNT) is connected; the port is activated and the pairing is started; the domain master sends the preset seed value inserted in a MAP-D frame to the end-point; the end-point receives the MAP-D frame and identifies the seed value of the strongest MAP-D frame among received MAP-D frames; the end-point tries link-up with the domain master with the identified seed-value; the domain master accepts the registration request with the seed value and connects link; the G.hn access multiplexer (GAM) identifies the MAC address of the end-point and sets up the MAC address as a registered address into the domain master; the G.hn access multiplexer (GAM) automatically saves the MAC address into the domain master, the G.hn access multiplexer (GAM) sets up the MAC addresses saved in the domain master at the initialization step of it; and the domain master connects a link only with the end-point having the MAC address.

As described above, the configuration of the present invention gives the following effects.

Firstly, the error of identifying different lines as the same lines cannot happen because a link is connected with a seed value and the MAC address is verified after connecting the link to form a domain.

Secondly, protocol-based MAC authentication is established and saved by the system so that the communication error between an operator and an installer.

Lastly, after activating a port and starting opening-up, all the process is carried out by the system from the initial step in which a domain master in G.hn access multiplexer (GAM) sends a MAP-D having a seed value to an end-point so that the present invention relieves pains of operators and installers and prevents errors due to the operators and installers.

### BRIEF DESCRIPTION OF THE DRAWINGS

For more complete understanding of this disclosure, reference is now made to the following brief description, taken in connection with the accompanying drawings and detailed description.

FIG. 1 shows a block diagram for representing the access network configuration based on the conventional DSL.

FIG. 2 shows a block diagram for the access network system forming a G.hn domain in accordance with the present invention and FIG. 3 shows a block diagram for representing the configuration of G.hn access multiplexer (GAM).

FIG. 4 and FIG. 5 show block diagrams for representing pairing method using MAC authentication in the access network being applied to G.hn specification in accordance with the present invention.

FIG. 6 shows a flow chart for illustrating the method applying the G.hn technology of the present invention to an access network in accordance with an embodiment of the present invention.

FIG. 7 and FIG. 8 show block diagrams for representing procedures before and after the opening-up forming a G.hn domain in accordance with the present invention.

FIG. 9 and FIG. 10 show flow charts for illustrating automatic pairing method for forming a G.hn domain in accordance with the present invention.

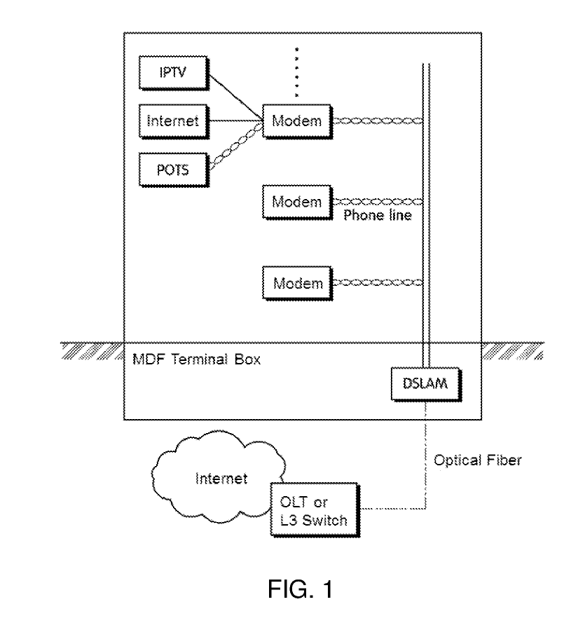

### DETAILED DESCRIPTION

The advantages, features, and the methods to achieve them are clarified in detail with reference to the embodiments in accordance with the present invention with accompanying figures.

However, the present invention is not limited to the embodiments described below but can be implemented in different and various ways; the present embodiments helps only to complete the implementation of the present invention and to inform those who have ordinary knowledge in the area the present invention belongs to about the complete category of the present invention; and the technical scope of the present invention is determined by the claims. The sizes of layers or areas and the relative sizes in the figures may be exaggerated for the purpose of clear explanation. Throughout the patent specification, the same reference mark designates the same component.

Hereinafter, the access network system being applied to G.hn technology in accordance with an embodiment of the present invention having the configuration described earlier is explained in detail with reference to accompanying figures.

The GIGA wire automatic pairing method in the present invention can be implemented in a G.hn specification based access network environment in which G.hn access multiplexer (GAM), of which multiple ports perform the function of domain master, and multiple terminals (GNT), which perform the function of end-points forming a G.hn domain, are connected with a bundle cable.

The G.hn specification based access network described earlier sends and receives signal synchronized at frequency between 20 Hz to 60 Hz in order to reduce crosstalk in the bundle cable and the domain master and the end-point can communicate with the synchronized signal using intrinsic seed value.

Particularly the domain master has an intrinsic seed before forming the G.hn domain but the end-point acquires the intrinsic seed in the domain forming procedure so as to reduce the crosstalk.

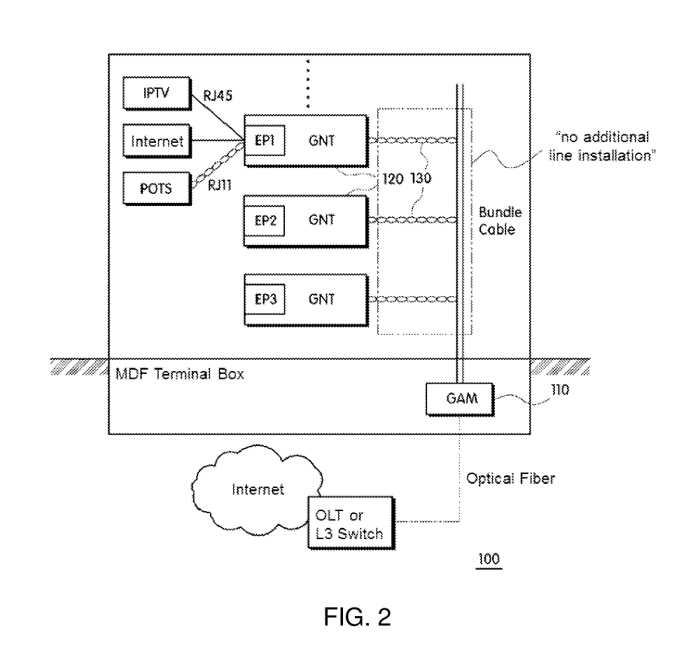

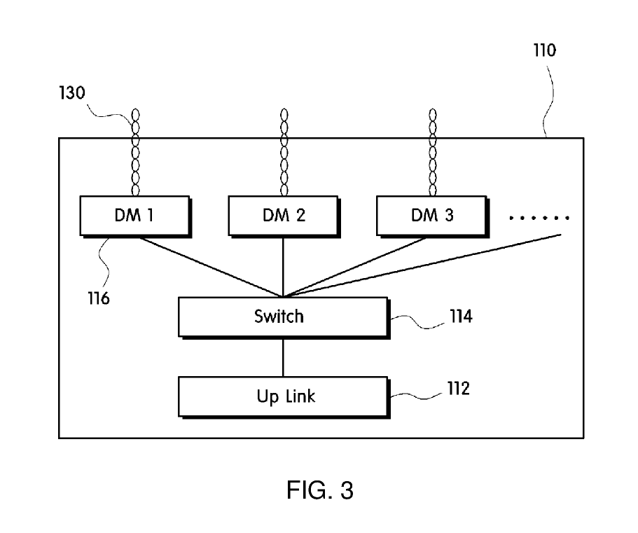

Referring to FIG. 2, the G.hn standard based access network system 100 reducing the crosstalk in a bundle cable in the present invention includes G.hn access multiplexer (GAM, or G.hn access multiplexer) 110 in which multiple ports function as domain masters; G.hn network terminal (GNT, or terminal) 120, which includes an end-point forming a G.hn domain with each domain master and has one-to-one correspondence with a domain master; and the phone line that connects the domain master and the end-point with a bundle cable 130.

The present invention applies G.hn standard to an access network to provide gigabit rate service. An embodiment in accordance with the present invention is described with an access network based on fiber to the phone line (FTTP). In case of FTTP based access network, for example, the G.hn access multiplexer (GAM) 110 is installed at MDF terminal box located in the basement of an apartment or a building or MDF terminal box located in every floor or every two or three floors and the terminal (GNT) 120 is installed at the subscriber side.

Referring to FIG. 3, the G.hn access multiplexer (GAM) 110 includes an uplink 112 connecting to the communication devices in the upper layer, a switch 114 providing synchronization signal to connected 8 or 24 domain masters, and a domain master consisting of 24 ports 116. Here the domain master (DM) defines a port 116 forming a G.hn domain with an end-point (EP).

The uplink 112 is connected with OLT in case of FITH or with L3 aggregation switch in case of DSL. The uplink can be 1 Gigabit Ethernet (GE) or 10 GE.

The switch (114) converts one 1 GE or 10 GE into 24 lines of 1 GE.

The domain master allocates and controls resources (e.g. bandwidth, priority, etc.) of all end-points belonging to the domain, and monitors the status of end-points. In particular, the domain master controls sending and receiving data with end-points and other operations according to the medium access plan (MAP).

The end-point is connected to the domain master (DM) with a bundle cable using a phone line 130 and communicates with it synchronized at frequency between 20 Hz to 60 Hz.

The terminal (GNT) 120 is connected with in-house IPTV and the internet using RJ45 connector or equivalent connector, or with in-house POTS using RJ11 connector or equivalent connector.

The phone line 130 can be aggregated into a bundle of 24 lines. As a communication medium, the phone line 130 is shown as an example but it is not limited to the phone line but UTP cable can also be used. For example, a pair of UTP cable can be used as GIGA wire in a pair of conventional phone line 130 or 4 pairs of UTP cable. In addition. CPEV, F/S, TIV can be used for connection.

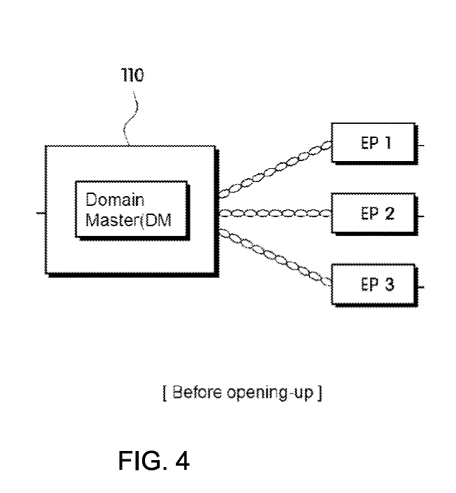

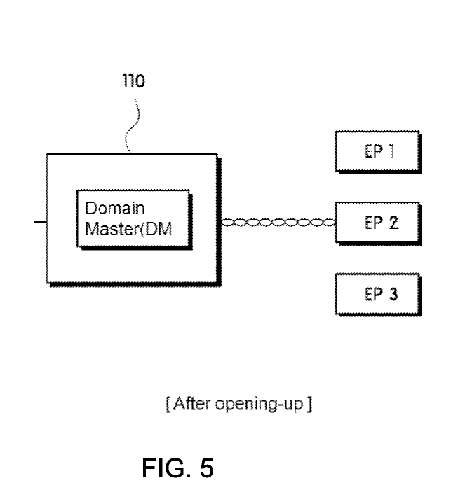

FIG. 4 is a block diagram for representing the access network being applied to G.hn specification before applying auto provisioning method using MAC authentication and FIG. 5 is a block diagram for representing the access network being applied to G.hn specification after applying the method.

Referring FIG. 4, to reduce crosstalk the G.hn access multiplexer (GAM) 110 and the domain master have a domain name and a seed value before opening-up (i.e. before applying the auto provisioning method). At the same time, the domain name and the seed value of the domain master and the end-points EP1, EP2, EP3 are set to a default value.

Referring FIG. 5, the operator registers MAC addresses of the specific end-points EP1, EP2, EP3 in the G.hn access multiplexer (GAM) 110 after opening-up (i.e. after applying the auto provisioning method). For example, the operator registers MAC addresses of a number of subscribers in the G.hn access multiplexer (GAM) 110. After registration, the G.hn access multiplexer (GAM) 110 searches the linked end-points EP1, EP2, EP3 to find the end-points EP1. EP2, EP3 having the same MAC addresses as the registered MAC addresses, and verifies registration or not of MAC addresses of end-points EP1, EP2, EP3 linked-up at the G.hn access multiplexer (GAM) 110.

Therefore, multiple end-points EP1, EP2, EP3 having MAC addresses registered at the G.hn access multiplexer (GAM) 110 can be linked up with it.

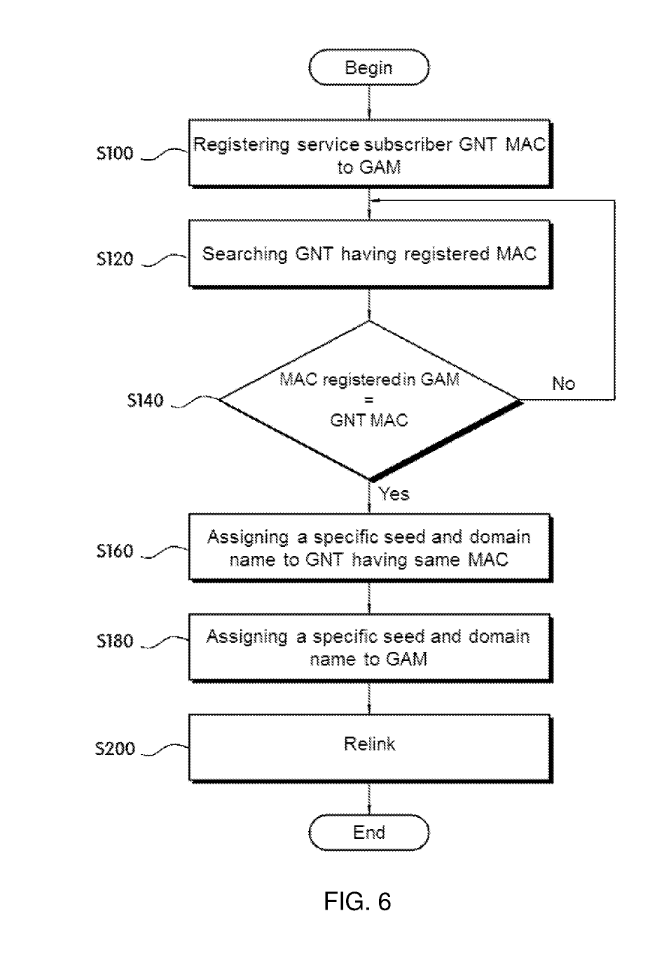

FIG. 6 is a flow chart for illustrating the method applying the G.hn technology of the present invention to an access network in accordance with an embodiment of the present invention.

Referring to FIG. 6. MAC addresses of service subscribers are registered at the G.hn access multiplexer (GAM) firstly (S100). In other words, the service operator registers the MAC addresses of multiple service subscriber terminals (CPE) at the G.hn access multiplexer (GAM).

The G.hn access multiplexer (GAM) searches terminals (CPE) having registered MAC addresses (S120), verifies agreement of the registered MAC address at the G.hn access multiplexer (GAM) and the MAC addresses of the terminal, and starts link-up with multiple terminals (CPE) having registered MAC addresses (S140).

Then, a specific seed value and domain name is given to a specific terminal (CPE) among terminals having registered MAC addresses (S160). In addition, the G.hn access multiplexer (GAM) sets up the same specific seed value and domain name given to the specific terminal (CPE) at the domain master (DM) so that the G.hn access multiplexer (GAM) can also have the same specific seed value and domain name given to the specific terminal (CPE) (S180).

Then, the G.hn access multiplexer (GAM) performs relink process to link the domain master (DM) in the G.hn access multiplexer (GAM) and the end-point in the terminal (CPE) using a specific domain name and seed value distinctly from others on a bundle cable so that it prevents crosstalk to keep the link from confusion and interference with other end-points (S200).

The pairing method described earlier improves crosstalk problem. But the seed values cannot be determined beforehand since it is unknown how domain masters (DM) and end-points EP1, EP2, EP3 are connected so that a default value is set up at factory shipment and additional opening-up process using MAC authentication between an operator and an installer is used.

However, the opening-up process can be cumbersome. Particularly when the domain master and the end-points EP1, EP2, EP3 are wired in opening-up process, the operator and the installer perform MAC authentication by remotely reading the label attached to the equipment but this opening-up process incurs a lot of errors in reading or listening the MAC address. In some cases, the label having the MAC address can often be lost in transportation or opening-up processes so that the installer cannot inform the operator of the MAC address.

Hence another embodiment of the present invention suggests a method to facilitate the opening-up process and reduce crosstalk at the same time.

As described above, the domain master (DM) and the end-point (EP) sends and receives signal synchronized at the specific frequency between 20 Hz to 60 Hz to reduce the crosstalk in a bundle cable.

Particularly in communicating with each other, the domain master (DM) and the end-point (EP) have an intrinsic seed to prevent identifying different lines as the same lines due to the crosstalk among adjacent lines in the bundle cable.

The domain master has an intrinsic seed before forming the G.hn domain. On the other hand, the end-point acquires the intrinsic seed during the G.hn domain forming procedure.

As described earlier, for example, the domain master (DM) uses a kind of control signal, MAP-D frame, to monitor data transmission with the end-point (EP) and the seed value of the domain master (DM) inserted in the MAP-D frame is sent to the end-point.

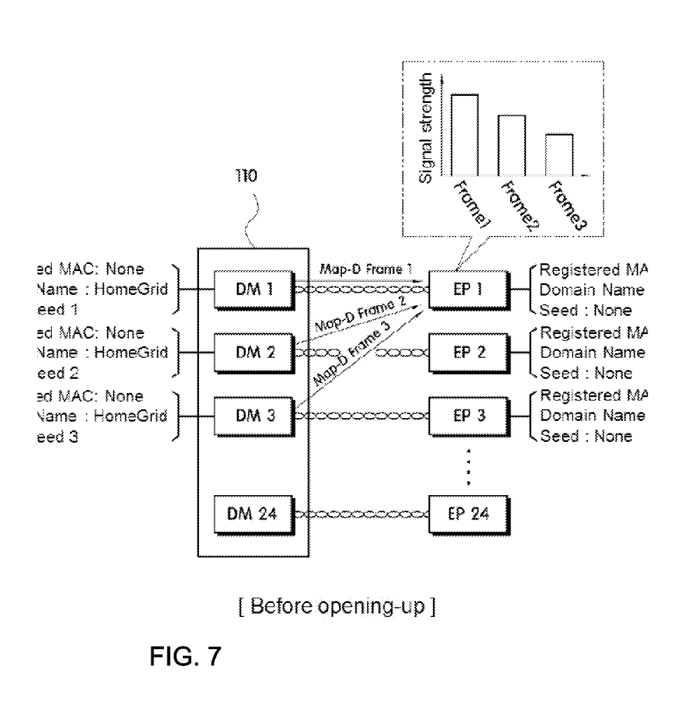

Referring to FIG. 7, the domain name of “HomeGrid” and the seed value of “Seed 1” for the first domain master (DM1), the domain name of “HomeGrid” and the seed value of “Seed 2” for the second domain master (DM2), the domain name of “HomeGrid” and the seed value of “Seed 3” for the third domain master (DM3) are determined at the time of factory shipment.

Contrarily the domain names of “HomeGrid” for the first end-point EP1, the second end-point EP2, and the third end-point EP3 are determined at the time of factory shipment but the seed values are not determined.

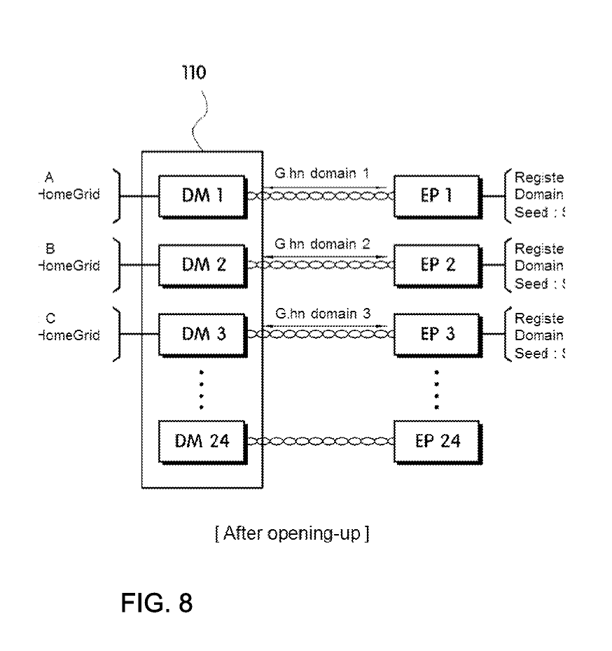

Referring to FIG. 8, the seed values for the first end-point EP1, the second end-point EP2, and the third end-point EP3 are determined by the pairing procedure of the opening-up process corresponding to the seed values of the domain masters DM1, DM2, DM3.

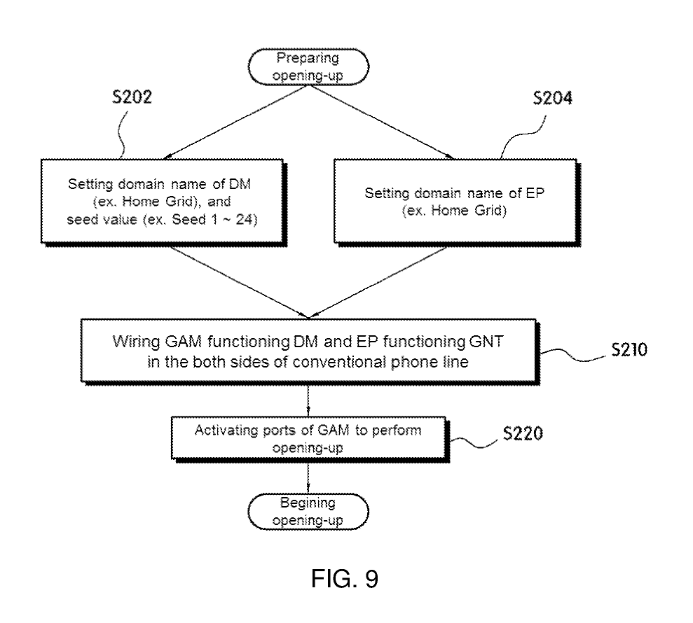

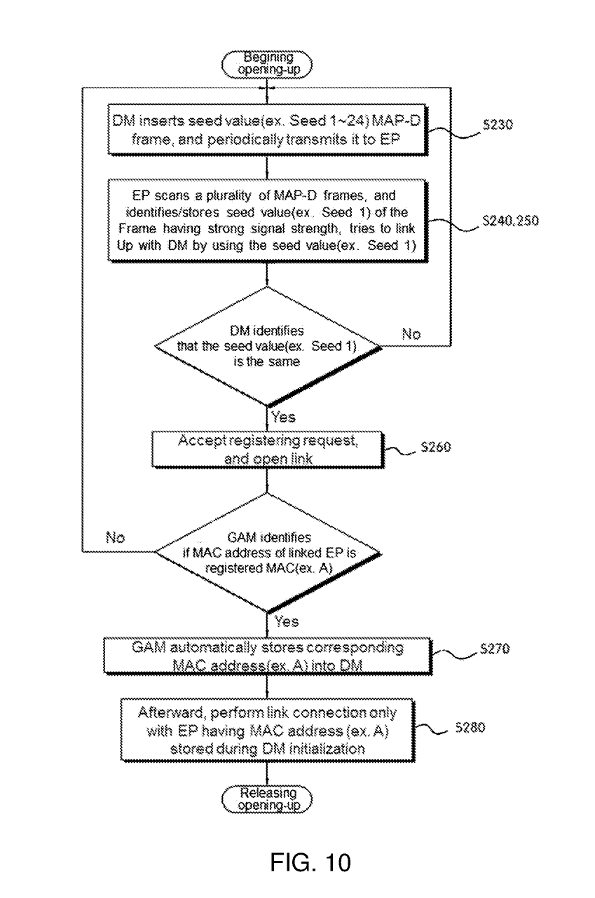

Hereinafter, with reference to FIG. 9 and FIG. 10, the opening-up process in which the domain master (DM) and the end-point (EP) form a G.hn domain on the access network is explained.

### <Preparation Step Before Opening-Up>

The domain name and the seed value for the domain master (DM) are determined beforehand (S202).

For example, the domain name of the domain master is defined as “HomeGrid”, and the seed values are defined as “Seed 1”, “Seed 2”, “Seed 3”, . . . , “Seed 298”, “Seed 299”, and etc so that an intrinsic seed value is given to each domain master. Normally, when the bundle cable consists of 24 pairs of phone line 130, the seed value can be determined from 1 to 24 and it can be varied with respect to the number of installed G.hn access multiplexer (GAM) 110.

The domain name for the end-point is determined beforehand (S204). But the seed value is not determined beforehand.

Since the domain master (DM) forms a G.hn domain with multiple end-points, the domain name of an end-point (EP) can be determined as “HomeGrid” beforehand. But the seed value cannot be determined since it is unknown how a domain master (DM) and an end-point (EP) are connected.

Before the opening-up, all ports performing domain master function in the G.hn access multiplexer (GAM) are in deactivated state.

<Auto Pairing Step after Opening-Up>

The wiring between the G.hn access multiplexer (GAM) 110 for a port to be opened and the terminal (GNT) 120 is connected (S210).

The installer installs the terminal (GNT) 120 at the site and the G.hn access multiplexer (GAM) 110 and the terminal (GNT) 120 are wired at both ends of the conventional phone line 130.

The operator activates the port 116 to be opened functioning as domain master and notifies the start of pairing for the port to be opened (S220).

The operator activates the port 116 to be opened upon the request of the installer. The opening-up procedures performed by the operator have completed at this step in the present invention. Afterwards the opening-up process is automatically performed by the system and a G.hn domain is formed by pairing each domain master and end-points.

The domain master sends the MAP-D frame including a preset seed value to the end-point (EP) before the start of pairing (S230).

The domain master inserts the preset seed value of it into a MAP-D frame at the preparation time of pairing and sends the frame to the end-point at the start time of pairing. Here the MAP-D frame is used to control registration and allocation or other operations as a G.hn communication protocol and in the present invention the seed value is inserted into the MAP-D frame.

The end-point (EP) receives a number of MAP-D frames and it identifies the seed value of the strongest MAP-D frame among received MAP-D frames and saves the seed value (S240).

As described earlier, when each port 116 functioning as domain master activates, the G.hn access multiplexer (GAM) (110) generates the MAP-D frame and sends it to the end-point (EP), and the end-point receives the MAP-D frame through filtering and modulation.

At this time, the end-point (EP) connected with the domain master (DM) by a phone line 130 scans a number of MAP-D frames (e.g. Frame 1, 2, 3) received from multiple domain masters (DM) through the bundle cable. The end-point also selects the MAP-D frame (e.g. Frame 1) having the strongest signal among a number of signals. By this way, the seed value (e.g. Seed 1) inserted in the MAP-D frame (e.g. Frame 1) is extracted and the end-point (EP) starts the registration procedure.

The end-point (EP) tries link-up with the domain master (DM) with the identified seed value (S250).

Since the end-point forms a link with the domain master using the intrinsic seed value as such, it cannot link with other physically adjacent end-points not forming the same domain.

The domain master admits a registration request having the same seed value and starts link-up process (S260).

The G.hn access multiplexer (GAM) 110 forms a G.hn domain using MAC address of the endpoint requesting registration because it has the information on MAC addresses of end-points before opening-up.

The G.hn access multiplexer (GAM) 110 verifies the MAC address of the linked end-point and sets the corresponding MAC as registered in the domain master, and it automatically saves the MAC address of the corresponding port into the domain master (DM) (S270).

The procedure to save the MAC address is automatically performed by protocol and the operator does not intervene in saving the MAC address of a terminal (GNT) 120.

Then the G.hn access multiplexer (GAM) 110 establishes the MAC addresses saved in the domain master at the initialization of domain master (DM) and the domain master (DM) sets up a link only with the end-points having the MAC addresses (S280).

For example, when the G.hn access multiplexer (GAM) 110 is powered on after blackout or re-activated from the deactivated state, the domain master (DM) identifies end-points (EP) having the established MAC addresses and sets up links so that a wrong G.hn domain is not formed among adjacent phone lines 130.

The end-point (EP) tries link-up with the saved seed value at the start of link-up procedure but if the link is not connected for a specified period of time, the end-point (EP) deletes the saved seed and repeats the above procedures.

### <Opening-Up Release Step>

The operator deletes the pairing information of the releasing port 116 (S310).

The G.hn access multiplexer (GAM) 110 deletes the MAC address of the end-point saved at the corresponding port 116 (S320).

The operator deactivates (Shutdown) the released port 116 (S330).

As explained above, the present invention relates a G.hn standard based access network system connecting the G.hn access multiplexer (GAM) in which multiple ports functions as domain masters and multiple terminals (GNT) which function as end-points forming a G.hn domain with the domain masters with a bundle cable and implementing automatic pairing method between the domain master and the end-point; the technical scope of the present invention includes the configuration that fundamentally prevents forming a wrong G.hn domain including not identical lines in which before the opening-up, the seed value is saved at the time of factory shipment and after the opening-up, the seed value inserted in the MAP-D frame is extracted and saved to the end-point. With regard to the technical scope of the present invention, various embodiments are made possible by those who have ordinary knowledge in the area the present invention belongs to.

1. An access network system for access network configured to:
connect an access multiplexer in which domain master performs master function at each port and access network terminals in which end-point performs client function, with a bundle of cables;
transmit and receive signals synchronized at a specific frequency to reduce crosstalk occurred in the bundle of cables; and
communicate the domain master and the end-point with the synchronized signal by using a unique seed value;
wherein the domain master acquires the unique seed value before forming a domain, and the end-point acquires the unique seed value in the process of forming the domain.

2. The access network system of claim 1, wherein the access multiplexer comprises:
an uplink connected to a FTTH-based OLT or DSL-based L3 aggregation switch with 1 GE or 10 GE;
a switch converting one 1 GE or 10 GE into 24 1 GE; and
the domain master comprising 24 ports and forming a domain with the end-point.

3. The access network system of claim 2, wherein the access multiplexer is configured to be installed at an MDF terminal box and connected to the upper layer communication equipment including an OLT or an L3 aggregation switch;
the access network terminal is configured to be installed at a subscriber side and connected with in-house IPTV, Internet and POTS.

4. A method for access network pairing, in which a domain is formed with an access multiplexer having domain master as port and an access network terminal having end-point at a subscriber side, the method comprises:
in the domain master, transmitting signal containing preset seed value to the end-point;
in the end-point, receiving the signal and identifying the seed value;
activating a port to be opened;
in the end-point, receiving the signal and identifying the seed value of the strongest signal among received signals;
in the end-point, trying to link-up with the domain master by using the identified seed value, and in the domain master accepting registration request with the seed value and starting link connection;
in the access multiplexer, identifying MAC address of the linked end-point, setting up the MAC address as a registered address into the domain master, and automatically storing the MAC address into the domain master, and
in the domain master, connecting link only with the end-point having the MAC address during initializing the domain master,
before activating the port to be opened,
connecting wire between the access multiplexer and the access network terminal by installer; and
informing start of pairing for the port by activating the port to be opened at the access multiplexer by operator;
and before starting the pairing,
assigning the seed value along with the domain name at the domain master; and
assigning only the domain name at the end-point.

5. (canceled)

6. The method for access network pairing of claim 4, wherein the signal includes an MAP-D frame controlling transmitting and receiving of data with the end-point and operations, and the seed value is included in the MAP-D frame.

7. A method for access network pairing of claim 4, between domain master and end-point, in which an access multiplexer in which multiple ports function as at least more than on of domain masters, an access network terminal comprising end-points forming a domain along with the domain master, and a bundle of cables connecting the domain master and the end-point, the method further comprises:
starting the opening-up by activating the port;
connecting link between the domain master and the end-point using the seed value; if the link is verified, in the access multiplexer, automatically registering MAC address of the end-point using the stored MAC address of the end-point; and
in the domain master, connecting only with the registered end-point in relink process.

8. The method for access network pairing of claim 7, wherein connecting link using the seed value comprises:
transmitting MAP-D frames including the preset seed value before opening-up from the domain master to the end-point;
receiving MAP-D frames at the end-point and identifying seed value of the strongest MAP-D frame among received MAP-D frames;
in the end-point, trying link-up with the domain master by using the identified seed value; and
in the domain master, starting to connect the link by accepting registration request with same seed value.

9. The method for access network pairing of claim 8, wherein automatically registering MAC address comprises:
in the access multiplexer, setting up the MAC address as a registered address into the domain master by identifying the linked MAC address of the end-point; and
in the access multiplexer, automatically storing the MAC address of the corresponding port into the domain master.

10. A method for access network pairing of claim 4, between domain master and end-point for forming a domain between an access multiplexer and an access network terminal connected by phone line, the method further comprises:
setting up domain name and seed vale of the domain master;
setting up domain name of the end-point;
connecting wire between the assess multiplexer and the access network terminal for the port to be opened;
activating the port and starting pairing;
in the domain master, inserting the preset seed value into MAP-D frames, and transmitting the MAP-D frames to the end-point;
in the end-point, receiving the MAP-D frames and identifying the seed value of the strongest signal of MAP-D frame among received MAP-D frames;
in the end-point trying to link-up with the domain master by using the identified seed value;
in the domain master, accepting registration request with the seed value and starts to connect the link;
in the access multiplexer, identifying the MAC address of the linked-up end-point, setting up the MAC address as a registered address into the domain master, and automatically storing the MAC address into the domain master; and
in the access multiplexer, setting up the MAC addresses stored in the domain master during initializing process, and connecting the link only with the end-point having the stored MAC addresses.

11. An access multiplexer configured to comprise:
an uplink communicating with upper layer communication equipments using optical fiber;
a switch converting one 1 GE or 10 GE into 24 1 GE; and
a domain master which communicates with a subscriber using phone line and transmits the signal including seed value as a control signal controlling data communication to the subscriber.

12. The access multiplexer of claim 11, wherein the control signal comprises MAP-frame and the seed value is inserted in the MAP-frame.

13. An access network terminal configured to:
be connected to one end of phone line;
receive preset seed value from domain master;
start to link-up with the received seed value and form a domain; and
thus perform an end-point function.

14. The access network terminal of claim 13, wherein to receive the seed value comprises scanning a plurality of received signals from the domain master, and identifying and storing the seed value of the strongest signal among the scanned signals.

15. A method for access network pairing of claim 4, between at least more than one access multiplexer having a plurality of ports and a plurality of terminals, the method further comprises:
registering MAC address of more than one terminal into the access multiplexer;
searching more than one terminal having the MAC address registered in the access multiplexer;
assigning specific domain name and seed value to one terminal of the searched terminals; and
assigning the same domain name and seed value as those assigned to the terminal to the access multiplexer.

16. The method for access network pairing of claim 15, wherein each port in the access multiplexer comprises domain master as a collection of nodes, the terminal having the MAC address registered in the access multiplexer comprises end-point, and the access multiplexer on a bundle of cables is connected with a link using the same domain name and seed value as those of the terminal.

17. The method for access network pairing of claim 15, the method further comprises:
connecting the domain master and the terminal in the relink process after assigning the same domain name and seed value as those assigned to the terminal to the access multiplexer.

18. The access network pairing method of claim 15, wherein the access network is a phone line based DSL access network.

19. The method for access network pairing of claim 16, wherein the port is replaced with the domain master and the terminal is replaced with the end-point, so as to apply the G.hn technology to the access network.

20. (canceled)
